(19) United States
(12) Patent Application Publication
(10) Pub. No.: US 2026/0030124 A1
(43) Pub. Date: Jan. 29, 2026

(54) DATABASE OBSERVABILITY SYSTEM

(71) Applicant: FMR LLC, Boston, MA (US)

(72) Inventors: Midhun Gandhi Thiagarajan, Cary, NC (US); Siddhanta Roy, Chennai (IN)

(21) Appl. No.: 18/785,701

(22) Filed: Jul. 26, 2024

(51) Int. Cl. G06F 11/20; G06F 11/34

(52) U.S. Cl. CPC G06F 11/2025; G06F 11/3409; G06F 2201/80; G06F 2201/81

(57) ABSTRACT

A computerized method is provided for managing replicated database resources. Systems and methods described can use a plurality of geographically distributed servers to query a replicated database and determine the databases health based on monitored golden signals in response to the query. The various servers can be geographically distributed and can report their database health findings to a monitoring agent which can use quorum logic based on all of the reporting servers to identify resource health and trigger failover to another instance of the replicated database when warranted. Such systems and methods can thereby detect not only hard failures but also so-called grey failures resulting in diminished resource performance and trigger failovers to increase resource performance.

### TECHNICAL FIELD

This application relates generally to systems, methods, and apparatuses, including computer program products, for database observability and proactive traffic routing.

### BACKGROUND

Databases and the data they contain are critical to the functionality and day-to-day operations of organizations and the software that supports those operations. Databases rely on multiple internal and external components to be fully functional and any of these components could partially fail leading to database outages. To avoid catastrophic loss of valuable data and/or program functionality, replicated databases are often used in which data is consistently backed-up to provide a redundant fallback for failover switching should a database fail. Unfortunately, some outages are only partial and, while negatively impacting performance, are hard to detect and do not result in switching. Moreover, such partial failures or diminished functionality, sometimes referred to as grey failures, can presage impending complete failure of the database.

Current technologies including Global Data Service (GDS) available from Oracle, Austin, Tx can detect hard failures and route traffic automatically within seconds. However, it is unable to sense ‘grey failures’ and ‘degraded performance’ modes. The current monitoring and recovery mechanisms in production did not work well to identify and fix these problems, which can lead to unexpected service interruption and long recovery times.

### SUMMARY

Database observability systems described herein can proactively identify potential issues and route database traffic before the issues become critical. The systems and methods herein can provide scalable and geo-distributed solutions that accurately and reliably detect database outages and route traffic using quorum-based decision logic. By reducing downtime, data loss, and toil, the described systems and methods can maintain business functionality, saving time and money. Systems and methods of the invention can include software redundancy at every layer, real-time alerting, and an on-call dashboard. The methods and systems described herein can be applied to multiple database platforms, both cloud and on-prem data centers. They may detect and react to both planned and unplanned failures, including hard and grey failures, by monitoring and interpreting various Golden Signals. Upon detecting hard failures or certain grey failures reaching a certain threshold, systems and methods of the invention can automatically route traffic, even before total failure in the case of grey failures, thereby ensuring key databases are always available.

Aspects of the invention can include a computerized method for managing replicated database resources. Steps of the method can include querying a first instance of a replicated database with a plurality of global service manager (GSM) servers; receiving, at each GSM server, a plurality of golden signals from the first instance of the replicated database in response to the query at each the plurality of GSM servers, separately determining database health for the first instance of the replicated database based on the received plurality of golden signals, wherein the database health comprises an indication of healthy or unhealthy and wherein one or more of the plurality of golden signals received by one of the plurality of GSM servers exceeding a threshold causes that GSM to provide an indication of unhealthy; receiving, at a monitoring agent, the database health indication from each of the plurality of GSM servers; comparing, at the monitoring agent, the database health indication received from each of the plurality of GSM servers; and triggering a failover switch to a second instance of the replicated database when a number of database health indications of unhealthy received from the plurality of GSM servers exceeds a threshold.

The comparing step can include tallying a total number of healthy indications and a total number of unhealthy indications and the threshold can include the total number of unhealthy indications exceeding the total number of healthy indications. Methods can include only triggering the failover switch where a total number of GSM servers from which the monitoring agent received the database health indication exceeds two. The first instance of the replicated database may be managed by global data services (GDS), the comparing step can further comprise determining if GDS is suspended and a last startup time for the first instance of the replicated database, and the threshold may further comprise a) the GDS not being suspended or b) the GDS being suspended and the last startup time for the first instance of the replicated database being less than 10 minutes.

In certain embodiments, the triggering step may be performed by one of the plurality of GSM servers. The triggering step can further comprise a first of the plurality of GSM servers triggering the failover switch and each remaining GSM server of the plurality of GSM servers, after a delay period, verifying that the first instance of the replicated database is down and, where the first instance of the replicated database is not down, triggering the failover switch. In some embodiments, the triggering step may comprise the one of the plurality of GSM servers verifying that the first instance of the replicated database is not down, then suspending GDS, and then resetting the first instance of the replicated database.

Methods of the invention may include creating a data log entry and reporting a failure where each of the plurality of GSM servers have triggered the failover switch and the first instance of the replicated database is not down. In some embodiments, methods can include creating a data log entry and reporting failover success after the first instance of the replicated database is verified down. The plurality of GSM servers may comprise at least six GSM servers, and wherein the plurality of GSM servers are located in at least two different data centers. The plurality of golden signals can comprise one or more selected from the group consisting of single value metrics, multi value metrics, and log file scanning metrics.

In various embodiments, the single value metrics can comprise two or more selected from the group consisting of host CPU utilization ratio, database wait time ratio, database CPU time ratio, average synchronous single-block read latency, user commits per second, user rollbacks per second, user transactions per second, SQL service response time, response time per transaction, average active sessions rate, redo generated per second rate, logons per second rate, database file sequential read time, database file scattered read time, direct path read time, direct path write time, database parallel write time, log file parallel write time, log file sync time, database file async I/O submit time, database file parallel read time processes ratio, sessions ratio, replication latency rate, and listener error success count rate. The querying, determining, receiving, and comparing steps may be initiated by a scheduling agent at selected intervals of 1 second or less.

In certain aspects, systems of the invention can include a computer system for managing replicated database resources. The system can comprise a processor in communication with a non-transient memory and operable to perform the steps of: querying a first instance of a replicated database with a plurality of global service manager (GSM) servers; receiving, at each server, a plurality of golden signals from the first instance of the replicated database in response to the query; at each the plurality of GSM servers, separately determining database health for the first instance of the replicated database based on the received plurality of golden signals, wherein the database health comprises an indication of healthy or unhealthy and wherein one or more of the plurality of golden signals received by one of the plurality of GSM servers exceeding a threshold causes that GSM to provide an indication of unhealthy; receiving, at a monitoring agent, the database health indication from each of the plurality of GSM servers; comparing, at the monitoring agent, the database health indication received from each of the plurality of GSM servers; and triggering a failover switch to a second instance of the replicated database when a number of database health indications of unhealthy received from the plurality of GSM servers exceeds a threshold.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for managing replicated database resources.

FIG. 2 shows an exemplary method for managing replicated database resources.

FIG. 3 is a diagram illustrating an exemplary structure of a system for managing replicated database resources.

FIG. 4a shows an exemplary architecture of a database account side of a system for managing replicated database resources.

FIG. 4b shows an exemplary architecture of an external account side of a system for managing replicated database resources.

FIG. 5 shows an exemplary system data flow diagram for managing replicated database resources according to certain embodiments.

FIG. 6 shows exemplary routing logic for managing replicated database resources according to certain embodiments.

FIG. 7 shows an exemplary user interface dashboard displaying database resource health.

### DETAILED DESCRIPTION

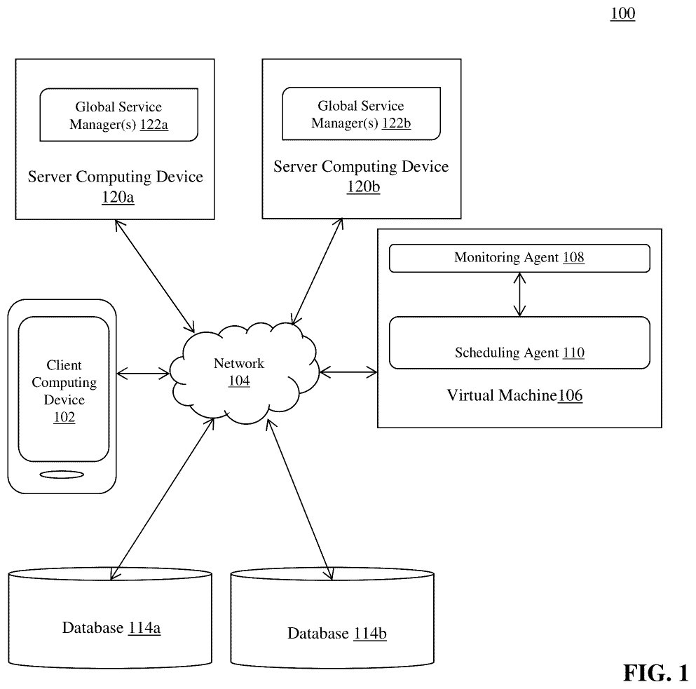

FIG. 1 is a block diagram of an exemplary system 100 for managing replicated databases. The system 100 includes a client computing device 102, a communications network 104, server computing devices (120a, 120b) that include a global service manager (GSM) 122a, 122b, and two or more instances of a replicated database 114a, 114b. The system 100 also includes a virtual machine (VM) 106 instance running a scheduling agent 110 and a monitoring agent 108.

The client computing device 102 connects to one or more communications networks (e.g., network 104) in order to communicate with the server computing device 120a and/or 120b, the one or more Databases (114a, 114b) and/or the VM 106 to interact with the GSM(s), access materials in the Databases (114a, 114b), and/or manage the monitoring and/or scheduling agent parameters. For example, an administrator may manipulate the monitored golden signals and/or thresholds thereof that the monitoring agent uses in determining failover switching between databases. The client computing device 102 may be used in the normal course of business to perform tasks that rely on the information stored in the replicated database (114a, 114b) such that the monitoring agent 108 can control the active instance of the replicated database 114a, 114b that the client computing device 102 communicates with depending on detected health of those database instances 114a, 114b.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used to provide input to and receive output from the server computing device 106. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., enter or approve time worked or request time off). Generally, a browser application comprises software executing on a processor of the client computing device 102 that enables the client computing device to communicate via HTTP or HTTPS with remote servers addressable with URLs (e.g., server computing device(s) 120a, 120b) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 106. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing devices 120a, 120b are devices including specialized hardware and/or software modules that execute on a processor and interact with memory modules of the server computing device 120, to receive data from other components of the system 100, transmit data to other components of the system 100, and perform functions such as hosting a global service manager (GSM) 122a, 122b, available from Oracle, Austin, TX or other management programming for use in workload management for replicated databases (e.g., Oracle's Global Data Services). The server computing device 120a, 120b can include any number of other programs that may execute on the processor of the server computing device 120a, 120b and each may, despite being disparate programs, rely on a regular exchange of data between them. In some embodiments, the GSM (122a, 122b) may be a specialized set of computer software instructions programmed onto one or more dedicated processors in the server computing device 120 and can include specifically designated memory locations and/or registers for executing the specialized computer software instructions.

Although two server computing devices 120a, 120b are shown each having a single GSM 122a, 122b, executing within the that server computing device 120, in some embodiments it may be preferrable to include additional server devices and GSMs that may be distributed in different geographic locations to provide additional datapoints in assessing database health. It should be appreciated that any number of computing devices, arranged in a variety of architectures, resources, and configurations (e.g., cluster computing, virtual computing, cloud computing) can be used without departing from the scope of the invention.

The replicated database 114a, 114b is a computing device (or in some embodiments, a set of computing devices) coupled to the server computing device 120a, 120b and one or more computing devices and/or programs that may rely on the data therein. They are configured to receive, generate, and store specific segments of data. In some embodiments, all or a portion of the database 114a, 114b can be integrated with the server computing device 120a, 120b or be located on a separate computing device or devices including distributed, cloud, or virtual computing systems. The database 114a, 114b can comprise one or more structures configured to store portions of data used by the other components of the system 100, as will be described in greater detail below.

In certain embodiments, a monitoring agent 108 and/or scheduling agent 110 may be housed on a server, a computing device, or, as depicted in FIG. 1, a virtual machine 106 in communication with the server computing devices 120a, 120b. The scheduling agent 110 may act to trigger the various GSMs 120a, 120b to query an instance of the database (e.g., 114a) at regular intervals or in response to specific events. The GSMs 120a, 120b can then each independently assess the health of the first instance of the replicated database 114a based on various golden signals received in response to the query and can forward that database health assessment to the monitoring agent 108. The monitoring agent 108 can decide the health of the first instance of the replicated database 114a based on a quorum logic applied to the health indications returned from the totality of monitoring GSM's and based on that determination, may trigger a failover to a second iteration of the replicated database 114b.

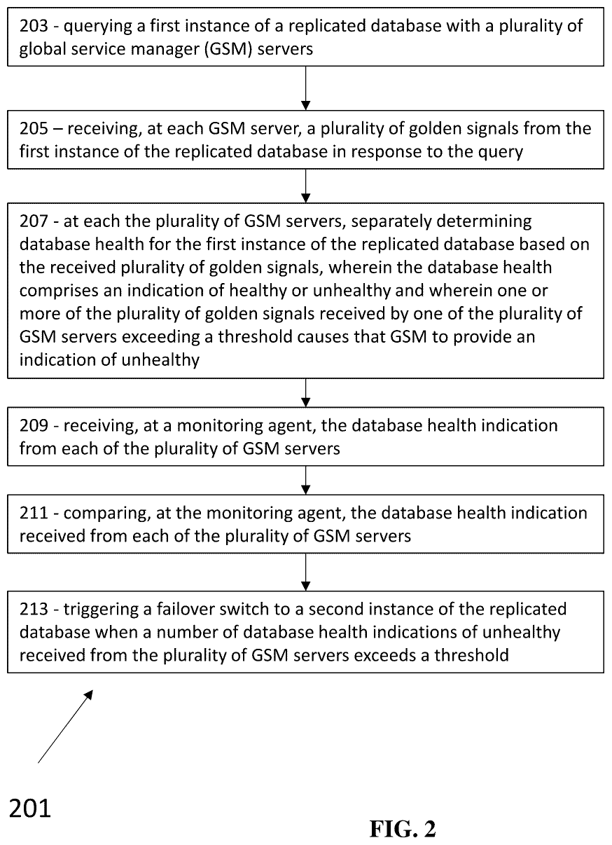

FIG. 2 shows an exemplary method 201 for managing replicated database resources. A plurality of global service manager (GSM) servers each query 203 a first instance of the replicated database. In certain embodiments, the plurality of GSM servers can include two, three, four, five, six, or more separate GSM servers. Various subsets of those GSM servers can be geo-distributed. That is, the GSM servers may be physically located in different geographic locations such as different states, different countries, different time zones, or different continents. In certain embodiments, the geographic distribution can help account for location-specific failures or service reductions. For example, if a below-threshold golden signal is related to the network path used by a specific GSM server to access the replicated database resource, there may be no specific issue with the resource and failover switching should not occur. Additional GSM servers in different physical locations may avoid such network communication issues and therefore allow the system to recognize that the database resource is functioning normally and should not be switched.

As the first instance of the replicated database responds to each GSM server's query, the GSM server will receive 205 and record values for various golden signals in the response. Golden signals provide insight into system health and can relate to latency, traffic, errors, and saturation. The monitored golden signals can include, for example, single value metrics, multi value metrics, and log file scanning metrics. Exemplary single value metrics can include one or more of, for example, host CPU utilization ratio, database wait time ratio, database CPU time ratio, average synchronous single-block read latency, user commits per second, user rollbacks per second, user transactions per second, SQL service response time, response time per transaction, average active sessions rate, redo generated per second rate, logons per second rate, database file sequential read time, database file scattered read time, direct path read time, direct path write time, database parallel write time, log file parallel write time, log file sync time, database file async I/O submit time, database file parallel read time processes ratio, sessions ratio, replication latency rate, and listener error success count rate. Other exemplary multi-value and log file scanning metrics can monitor, for example, one or more logs such as GG replication showing end-to-end latency per replication in a GoldenGate database replication system as available from Oracle, Austin, TX, Tablespace log showing percentage of free tablespace per pluggable database (PDB), per EBS metric showing percentage utilized per elastic storage block volume, alert logs, listener logs, crs logs, ASM logs, and var log messages looking for known patterns.

Based on the received golden signals, each of the plurality of GSM servers can separately determine 207 database health for the first instance of the replicated database. The database health can include an indication of healthy or unhealthy. The indication can be unhealthy when one or more of the plurality of golden signals received by one of the plurality of GSM servers exceeds a limit. In various embodiments, the GSM may determine 207 that the database instance is unhealthy if even a single monitored golden signal is outside of accepted parameters, if 25% or more of the monitored golden signals are outside of accepted parameters, if 50% or more of the monitored golden signals are above or below a preset limit, or any other selected number or percentage of golden signals are outside of accepted parameters. The individual limits for each monitored golden signal as well as the acceptable threshold for the number of out-of-spec golden signals that will trigger an unhealthy indication from the monitoring GSM can be manipulated by an administrator via an input mechanism such as a control dashboard.

A monitoring agent can then receive 209 and compare 211 the database health indication from each of the plurality of GSM servers. Where the number of database health indications of unhealthy received from the plurality of GSM servers exceeds a threshold, a failover switch to a second instance of the replicated database can be triggered 213. In various embodiments, the threshold for triggering the failover switch may be the number of unhealthy indications exceeding the number of healthy indications. In some embodiments, to prevent unwarranted failover where something may be wrong with the monitoring GSM servers or the monitoring agent, failover may be limited to situations where more than two GSM servers (out of, for example six) provide a health indication.

The replicated database may be managed by global data services (GDS), Oracle, Austin, Tx. The comparing step may further comprise determining if GDS is suspended and a last startup time for the first instance of the replicated database such that failover will only be triggered when GDS has not been suspended or the GDS has been suspended but the last startup time for the first instance of the replicated database being less than 10 minutes. The actual triggering step for failover switching can be performed by one of the plurality of GSM servers. The triggering process can include a first of the plurality of GSM servers triggering the failover switch and each remaining GSM server of the plurality of GSM servers, after a delay period, verifying that the first instance of the replicated database is down and, where the first instance of the replicated database is not down, triggering the failover switch. The triggering step can include one of the plurality of GSM servers verifying that the first instance of the replicated database is not down, then suspending GDS, and then resetting the first instance of the replicated database. In various embodiments, a data log can be created by the monitoring agent, the failover triggering GSM server, or other module along with a report of the failure. In instances where each of the plurality of GSM servers have triggered the failover switch and the first instance of the replicated database is still not down an error log can be created and/or a notification sent to an administrator indicating unsuccessful failover and a need for manual intervention. Systems and methods of the invention can include a scheduling agent to initiate the querying, determining, receiving, and comparing steps at selected intervals. Those intervals can be every 5 minutes, every minute, every 45 seconds, every 30 seconds, every 15 seconds, every 10 seconds, every 5 seconds, or, preferably, every 1 second or less.

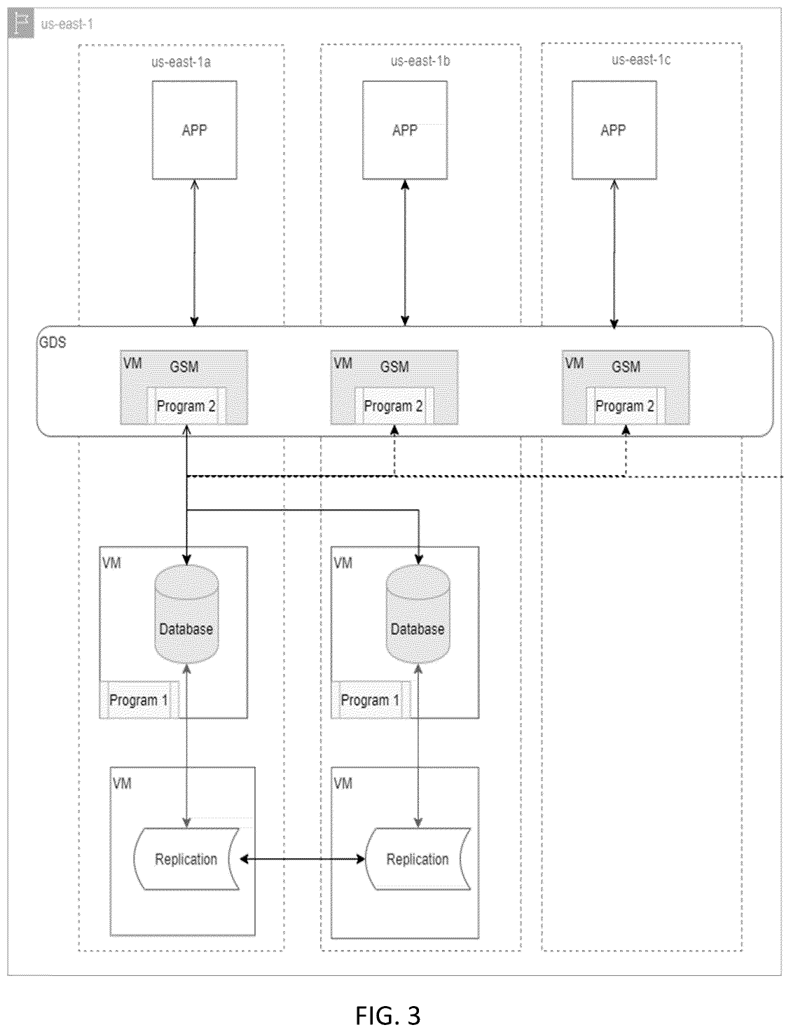

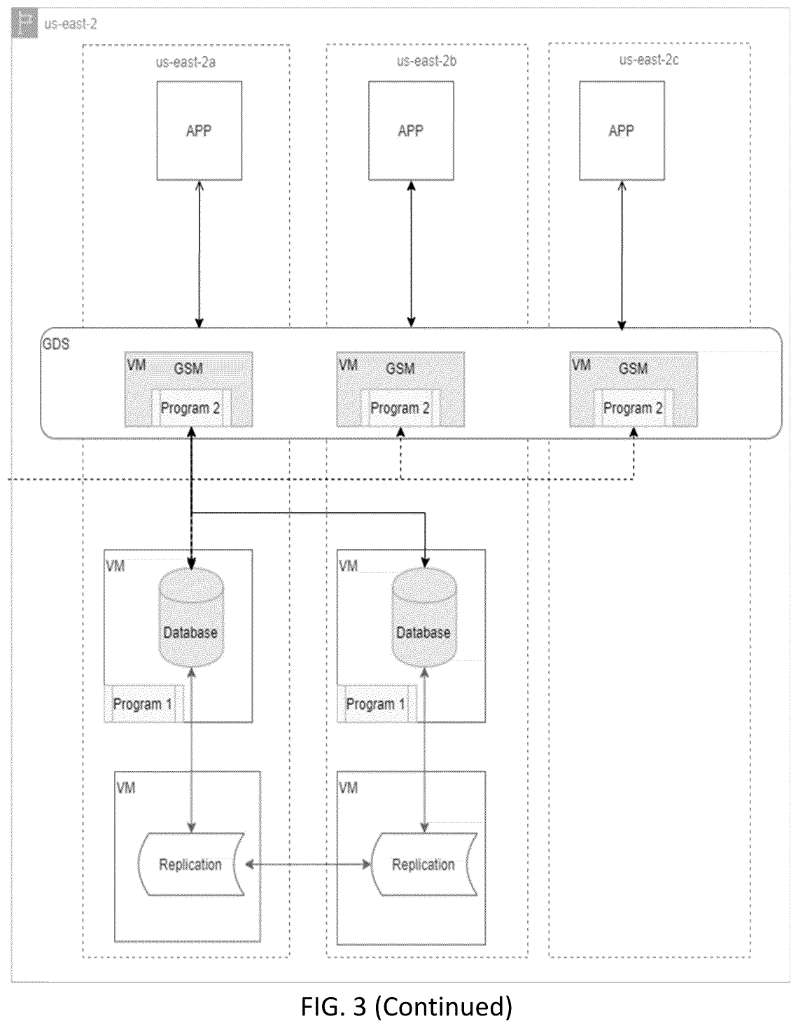

FIG. 3 is a diagram illustrating an exemplary structure of a system for managing replicated database resources. Of note, the GSM servers are distributed in VMs running in different geographically separate data centers while querying the replicated databases.

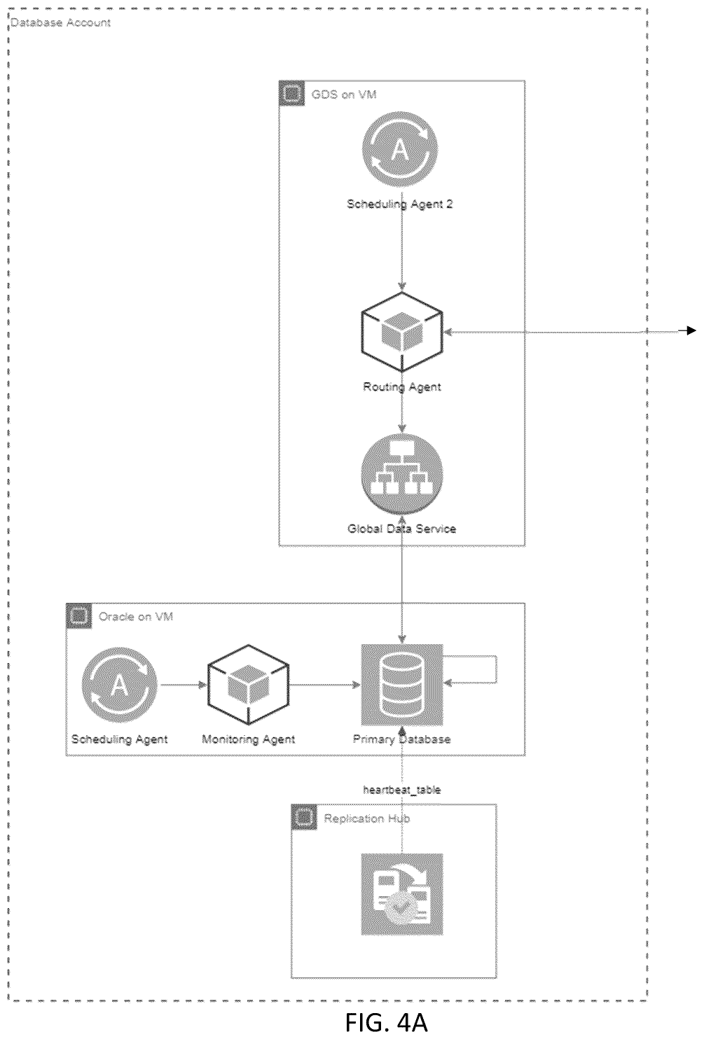

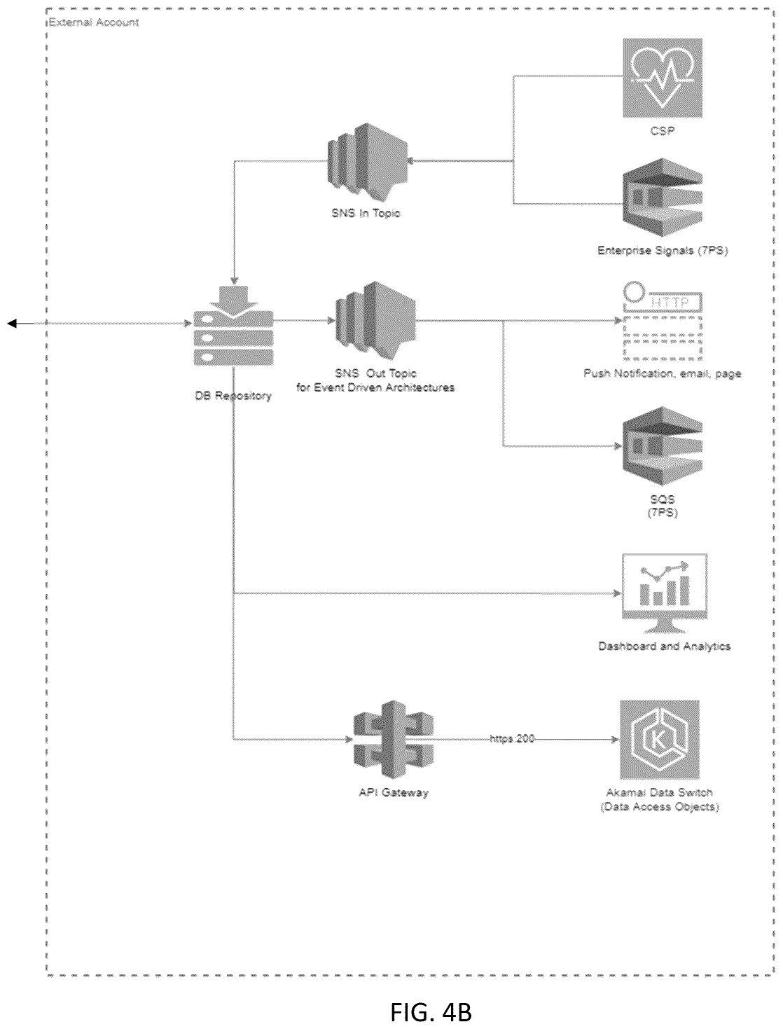

FIG. 4a shows an exemplary architecture of a database account side of a system for managing replicated database resources and FIG. 4b shows an exemplary architecture of an external account side of a system for managing replicated database resources. The routing agent on the database account side manages communication with the database repository on the external account side.

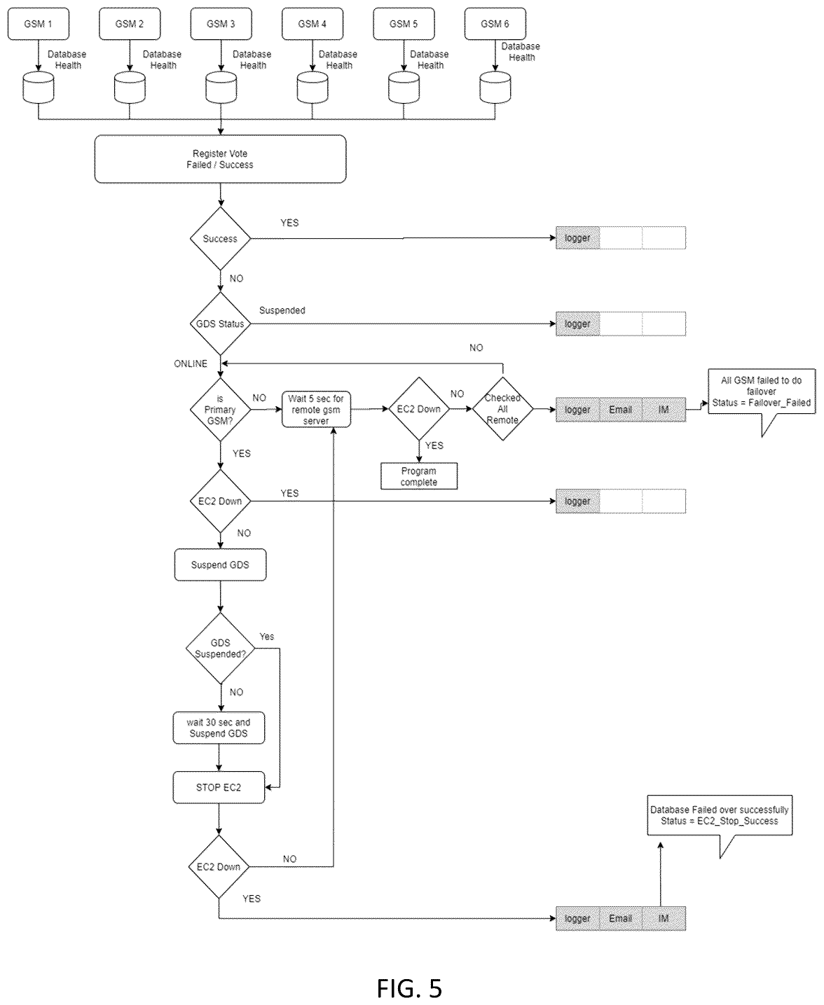

FIG. 5 shows an exemplary system data flow diagram for managing replicated database resources according to certain embodiments. In the illustrated example, the system performs failover in 2 phases. First it determines the health of databases and, if the target database is unhealthy, it performs the failover by suspending the Database Endpoints (GDS Services) and stopping the database instance (e.g., an elastic compute cloud EC2 instance in an Amazon environment). To determine an unhealthy Database in the example, 6 GSM servers deployed across datacenters will check the Golden Metrics for all databases. Each GSM Servers will then register their vote for monitored databases where 0—Register SUCCESS and 1—Register FAILED. Each GSM server will validate the voting registered by other GSM servers and decide if the database is healthy or unhealthy. If the number of FAILED vote is greater than 2 and number of FAILED is greater than Total number of SUCCESS votes, the target database is considered UNHEALTHY and Failover will be triggered.

If GDS Services are already Suspended and the Database EC2 instances “last startup time” is more than 10 min, the system may assumes that it is a “planned maintenance activity” and will not perform any failover. If GDS Services are suspended and the Database EC2 last startup time is less than 10 min, the system can assume that someone has started the EC2 without following the proper manual steps and will trigger Failover

In the example illustrated in FIG. 5, the failover steps include: a 1st GSM assuming the master role and triggering failover while the rest of the GSMs wait for 5 sec. After 5 sec, the other GSMs will check if failover is done. If failover is done, they will skip. If not, a 2nd GSM in the chain will become Master and will try to execute failover. This cycle will run until failover succeeds or all GSM tried the failover. If failover is still unsuccessful, an incident will be logged and reported for manual intervention.

The failover steps performed by each GSM in the chain include, the first GSM will check if Database EC2 is Down. If the database EC2 is down, it will skip. If not, this GSM will suspend GDS Services of the unhealthy database. If GDS Services are suspended successfully, the GSM will trigger a Stop EC2 instance command. If GDS Services cannot be suspended, the GSM will wait for 30 sec and retry the GDS Services suspend operation. If, after 30 seconds. GDS suspend fails, the GSM will trigger Stop EC2 instance command. The GSM will then check if EC2 is down. If it is, then failover is completed. If not, the next GSM becomes master and attempts the above steps and so on as described above. ack to step 5 and next GSM in the queue will become master and trigger failover.

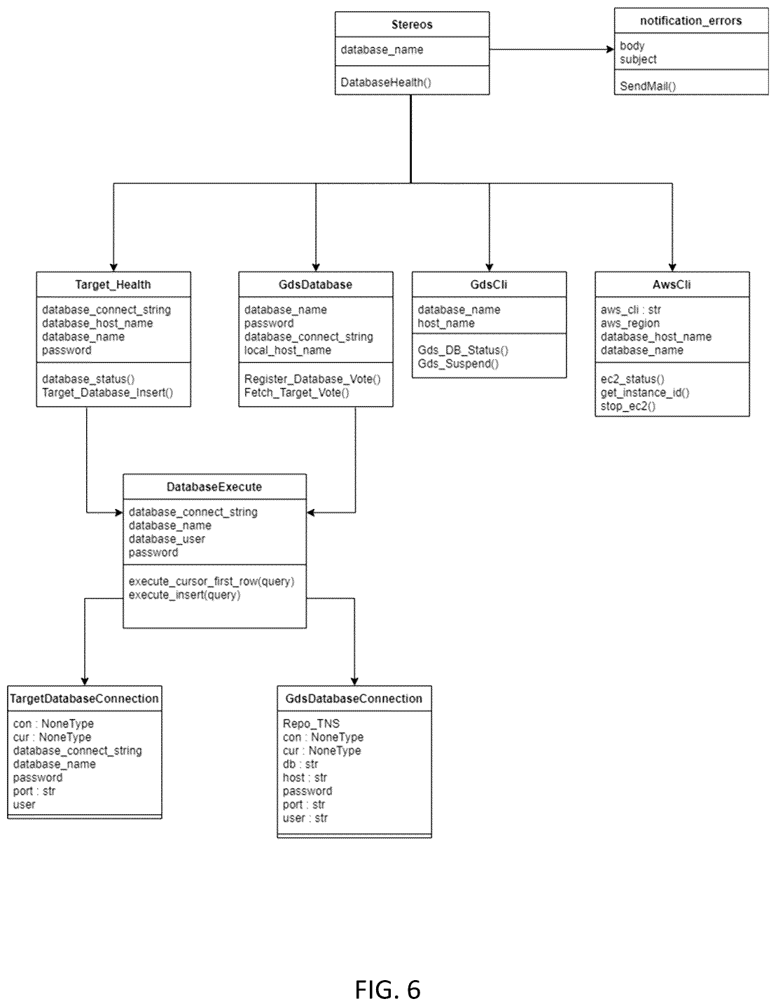

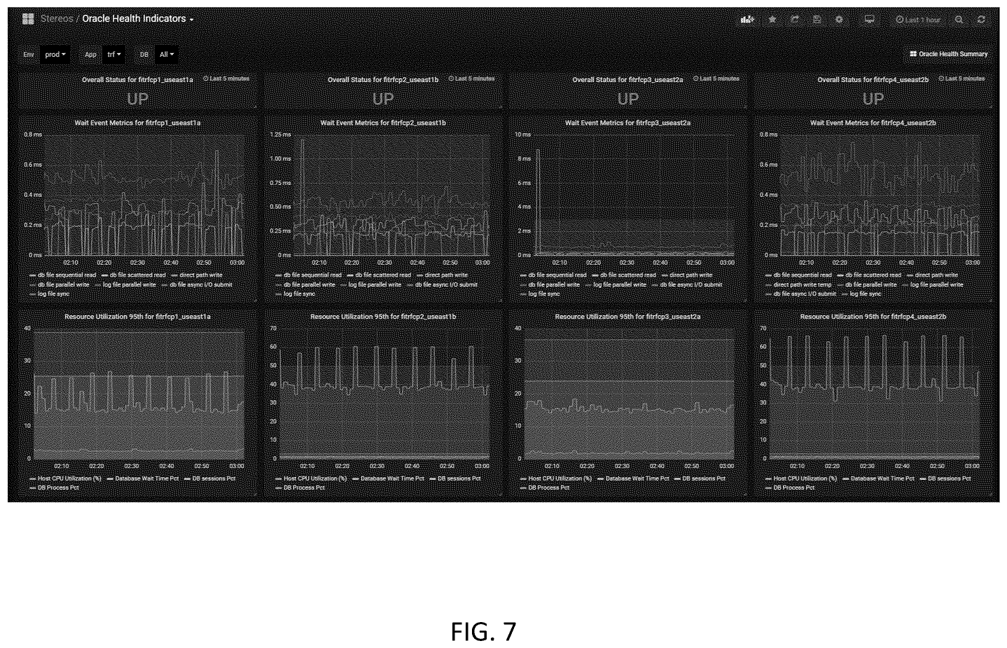

FIG. 6 shows exemplary routing logic for managing replicated database resources according to certain embodiments. FIG. 7 shows an exemplary user interface dashboard displaying database resource health. Such a dashboard may be fed real-time data from the monitoring agent and/or the various GSM servers including monitored golden signal metrics and allow an administrator to monitor the resource health and automated failover activity.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for managing replicated database resources, the method comprising:
querying a first instance of a replicated database with a plurality of global service manager (GSM) servers;
receiving, at each GSM server, a plurality of golden signals from the first instance of the replicated database in response to the query;
at each the plurality of GSM servers, separately determining database health for the first instance of the replicated database based on the received plurality of golden signals, wherein the database health comprises an indication of healthy or unhealthy and wherein one or more of the plurality of golden signals received by one of the plurality of GSM servers exceeding a threshold causes that GSM to provide an indication of unhealthy;
receiving, at a monitoring agent, the database health indication from each of the plurality of GSM servers;
comparing, at the monitoring agent, the database health indication received from each of the plurality of GSM servers; and
triggering a failover switch to a second instance of the replicated database when a number of database health indications of unhealthy received from the plurality of GSM servers exceeds a threshold.

2. The computerized method of claim 1, wherein the comparing step comprises tallying a total number of healthy indications and a total number of unhealthy indications; and
wherein the threshold comprises the total number of unhealthy indications exceeding the total number of healthy indications.

3. The computerized method of claim 2, further comprising only triggering the failover switch where a total number of GSM servers from which the monitoring agent received the database health indication exceeds two.

4. The computerized method of claim 1, wherein the first instance of the replicated database is managed by global data services (GDS);
wherein the comparing step further comprises determining if GDS is suspended and a last startup time for the first instance of the replicated database; and
wherein the threshold further comprises a) the GDS not being suspended or b) the GDS being suspended and the last startup time for the first instance of the replicated database being less than 10 minutes.

5. The computerized method of claim 4, wherein the triggering step is performed by one of the plurality of GSM servers.

6. The computerized method of claim 5, wherein the triggering step further comprises a first of the plurality of GSM servers triggering the failover switch and each remaining GSM server of the plurality of GSM servers, after a delay period, verifying that the first instance of the replicated database is down and, where the first instance of the replicated database is not down, triggering the failover switch.

7. The computerized method of claim 5, wherein the triggering step comprises the one of the plurality of GSM servers verifying that the first instance of the replicated database is not down, then suspending GDS, and then resetting the first instance of the replicated database.

8. The computerized method of claim 6, further comprising creating a data log entry and reporting a failure where each of the plurality of GSM servers have triggered the failover switch and the first instance of the replicated database is not down.

9. The computerized method of claim 6, further comprising creating a data log entry and reporting failover success after the first instance of the replicated database is verified down.

10. The computerized method of claim 1, wherein the plurality of GSM servers comprises at least six GSM servers, and wherein the plurality of GSM servers are located in at least two different data centers.

11. The computerized method of claim 1, wherein the plurality of golden signals comprise one or more selected from the group consisting of single value metrics, multi value metrics, and log file scanning metrics.

12. The computerized method of claim 11, wherein the single value metrics comprise two or more selected from the group consisting of host CPU utilization ratio, database wait time ratio, database CPU time ratio, average synchronous single-block read latency, user commits per second, user rollbacks per second, user transactions per second, SQL service response time, response time per transaction, average active sessions rate, redo generated per second rate, logons per second rate, database file sequential read time, database file scattered read time, direct path read time, direct path write time, database parallel write time, log file parallel write time, log file sync time, database file async I/O submit time, database file parallel read time processes ratio, sessions ratio, replication latency rate, and listener error success count rate.

13. The computerized method of claim 1, wherein the querying, determining, receiving, and comparing steps are initiated by a scheduling agent at selected intervals of 1 second or less.

14. A computer system for managing replicated database resources, the system comprising a processor in communication with a non-transient memory and operable to perform the steps of:
querying a first instance of a replicated database with a plurality of global service manager (GSM) servers;
receiving, at each GSM server, a plurality of golden signals from the first instance of the replicated database in response to the query
at each the plurality of GSM servers, separately determining database health for the first instance of the replicated database based on the received plurality of golden signals, wherein the database health comprises an indication of healthy or unhealthy and wherein one or more of the plurality of golden signals received by one of the plurality of GSM servers exceeding a threshold causes that GSM to provide an indication of unhealthy
receiving, at a monitoring agent, the database health indication from each of the plurality of GSM servers;
comparing, at the monitoring agent, the database health indication received from each of the plurality of GSM servers; and
triggering a failover switch to a second instance of the replicated database when a number of database health indications of unhealthy received from the plurality of GSM servers exceeds a threshold.

15. The computer system of claim 14, wherein the comparing step comprises tallying a total number of healthy indications and a total number of unhealthy indications; and
wherein the threshold comprises the total number of unhealthy indications exceeding the total number of healthy indications.

16. The computer system of claim 15, further operable to trigger the failover switch only where a total number of GSM servers from which the monitoring agent received the database health indication exceeds two.

17. The computer system of claim 14, wherein the first instance of the replicated database is managed by global data services (GDS);
wherein the comparing step further comprises determining if GDS is suspended and a last startup time for the first instance of the replicated database; and
wherein the threshold further comprises a) the GDS not being suspended or b) the GDS being suspended and the last startup time for the first instance of the replicated database being less than 10 minutes.

18. The computer system of claim 17, wherein the triggering step is performed by one of the plurality of GSM servers.

19. The computer system of claim 18, wherein the triggering step further comprises a first of the plurality of GSM servers triggering the failover switch and each remaining GSM server of the plurality of GSM servers, after a delay period, verifying that the first instance of the replicated database is down and, where the first instance of the replicated database is not down, triggering the failover switch.

20. The computer system of claim 18, wherein the triggering step comprises the one of the plurality of GSM servers verifying that the first instance of the replicated database is not down, then suspending GDS, and then resetting the first instance of the replicated database.
